(19) United States
(12) Patent Application Publication
(10) Pub. No.: US 2007/0002210 A1
(43) Pub. Date: Jan. 4, 2007

(54) System for automatically adjusting screen display effect according to ambient brightness

(75) Inventors: David Ho, Taipei (TW); Zheng Zhang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/476,862

(22) Filed: Jun. 29, 2006

(30) Foreign Application Priority Data
Jul. 1, 2005 (TW) 094122363

(51) Int. Cl. G02F 1/1335

(52) U.S. Cl. 349/61

(57) ABSTRACT

A system for automatically adjusting illumination of a screen according to the ambient brightness includes a detecting module and a central processing module. After the detecting module detects the ambient brightness, a set of data are generated by the central processing module of the system, then the central processing module will compare the set data with a predetermined data stored in a storage device module of the system. In the storage device module, the predetermined data represent a plurality of different brightness levels, and the set of data is also compared with the previously sampled data, and the result is used to determine whether or not to adjust the current backlight display illumination of a screen display module of the system. Adjusting the backlight display illumination of a keypad display module of the system can save the power of a battery installed in the system.

### FIELD OF THE INVENTION

The present invention relates to a system for adjusting illumination of a screen of handheld device and more particularly to a system for automatically adjusting illumination of a screen of the handheld device according to the ambient brightness.

### BACKGROUND OF THE INVENTION

As the present electronic technologies in the high-tech and electronic communication industries are developed in an amazingly fast speed, various novel, refined, compact, multifunctional and easy-to-operate electronic handheld devices such as mobile phones and personal digital assistants (PDA) are introduced to the market constantly, and these electronic handheld devices become the most popular products among the electronic products due to their light, super-thin, portable and exquisite features.

As the multimedia functions of the handheld devices are enhanced, users start using them for reading e-books and watching movies, and users can enjoy the convenience brought by these handheld devices anywhere and anytime. However, there exists a problem that the handheld device is generally carried by users and used in different outdoor environments, and thus it is important to maintain the best condition of a backlight display of a screen such as a liquid crystal display (LCD) of the handheld device, so as to permit users to read an e-book or watch movies easily, but the brightness of the outdoor environments varies all the time, and the illumination of the screen in different outdoor environments will be different. In a bright environment, users may not be able to view the screen clearly, and their eyes may get tired easily.

At present, some handheld devices provide a traditional manually-adjusting way for a user to turn on or off the backlight of the screen. After the backlight function is enabled, users can press a button on the handheld device to turn on the backlight of the screen at daytime or nighttime, or users can adjust the illumination and contrast of the backlight of the screen manually by an operating interface of the handheld device.

Although the aforementioned method used by manufactures to overcome the backlight problem of the screen of the handheld device and users can view the screen clearly at nighttime or in a darker environment, it is very inconvenient and unfriendly for users to manually and frequently adjust the backlight control of the screen. As a result, the backlight function is generally enabled regardless of daytime or nighttime, and the backlight of the screen will consume or waste a great deal of battery power of the handheld device while enabling the backlight function all the time.

Therefore, finding a way to overcome the problem of manually adjusting the illumination of the screen automatically according to the ambient brightness to avoid an unclear display of a screen is very important.

### SUMMARY OF THE INVENTION

In view of the foregoing shortcomings of the prior art screen of the handheld device, different display effects will be produced in different outdoor environments, such that when the light is intensive, users will not be able to view the screen display clearly or their eyes will get tired easily, and the traditional way of adjusting the illumination and contrast of the backlight of the screen is inconvenient and unfriendly for users to manually and frequently adjust the backlight of a screen, and even causes a waste of battery power of the handheld device. Thus the inventor of the present invention based on years of experience conducts extensive researches and experiments and finally developed a system for automatically adjusting illumination of a screen of handheld device according to the ambient brightness.

Therefore, it is a primary objective of the present invention to overcome the foregoing shortcomings of the screen of traditional handheld devices by providing a handheld device such as a mobile phone and a personal digital assistant (PDA) that comprises a detecting module, such that after the detecting module detects the ambient brightness and samples a data and sends the data to a central processing module of the handheld device, the central processing module will match the data with a predetermined data in a storage device module of the handheld device. In the storage device module, the predetermined data contains a plurality of different brightness levels, and the data is also compared with a previously sampled data, and the compared result is used for determining whether or not to adjust the illumination of a screen display module such as a liquid crystal display (LCD) of the handheld device. In the meantime, the backlight display brightness of a keypad display module of the handheld device is adjusted to save the power of a battery installed in the handheld device, so as to make the display of the screen display module brighter and more colorful, and the contrast more suitable to user's eyes.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic block diagram of the invention;

FIG. 2 is a flow chart of a preferred embodiment of the invention; and

FIG. 3 is a flow chart of manually setting parameters according to a preferred embodiment of the invention.

### DETAILED DESCRIPTION OF THE PREFERRED EMBODIMENTS

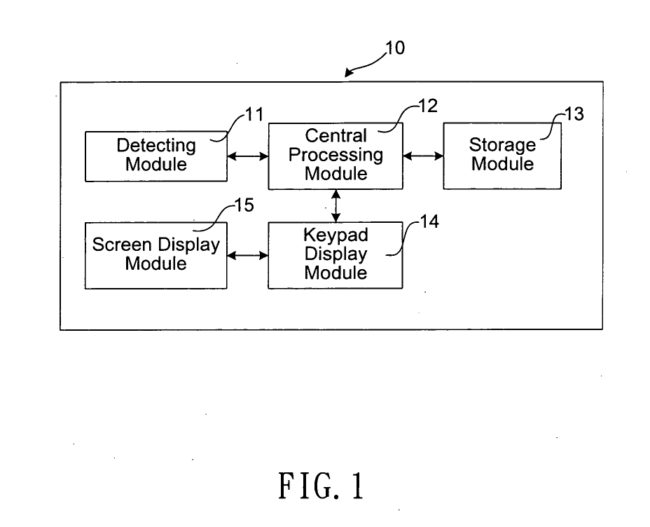

Referring to FIG. 1 for a system for automatically adjusting illumination of a screen according to the ambient brightness of the present invention, the system of the invention is a handheld device 10 such as a mobile phone or a personal digital assistant (PDA). The handheld device comprises a detecting module 11 and a central processing module 12. After the detecting module 11 detects ambient brightness, a central processing module 12 installed in the handheld device 10 will process the following procedures according to the ambient brightness:

Firstly, a set of data is generated by detecting and sampling the ambient brightness and is compared with predetermined brightness data that represent a plurality of different brightness levels and are stored in a storage module 13 of said handheld device 10.

Secondly, the result of the comparison between the set of data and said predetermined brightness data is used for determining whether or not to adjust illumination of a screen display module 15 such as a liquid crystal display (LCD) of the handheld device 10.

In a preferred embodiment of the present invention, the detecting module 11 comprises a transducer and a conversion chip, wherein the transducer is provided for detecting the ambient brightness, and the conversion chip is provided for sampling and performing analog-to-digital conversion to generate the set of data representing said ambient brightness. The storage device module 13 stores a predetermined data having a plurality of different brightness levels, and the predetermined data consists of levels distributed from darkness to brightness such as Very Dark, Dark Level 1, Slight Dark Level 2, Normal Brightness, Slightly Bright Level 2, Bright Level 1, and Very Bright.

When a user uses the handheld device 10 of the present invention while the user is walking, the central processing module 12 in the handheld device 10 will generate a set of data by detecting and sampling the ambient brightness according to the detection of the detecting module 11 and compare the set of data with the predetermined data in the storage device module 13. In the meantime, the set of data is compared with the previously sampled data, and the result of the comparison between the set of data and said predetermined brightness data is used for determining whether to change the ambient brightness from darkness to brightness or from brightness to darkness. Finally, the actual detected result is used for determining whether or not to adjust the backlight display illumination and the contrast of the screen display module 15 for automatically adjusting the backlight display illumination and the contrast of the screen display module 15 as well as adjusting the backlight display illumination of a keypad display module 14 of the handheld device 10, so as to save the power of a battery installed in the handheld device 10.

In other words, the illumination of a keypad display module 14 of the handheld device 10 in a bright environment will not be obvious, when the user is walking from a darker environment to a brighter environment, and thus it will consume more battery power. When the present invention automatically adjusts the backlight display illumination and the contrast of the screen display module 15 to lower the backlight display illumination of the keypad display module 14 or turn off the backlight of the keypad display module 14, the battery power can be saved.

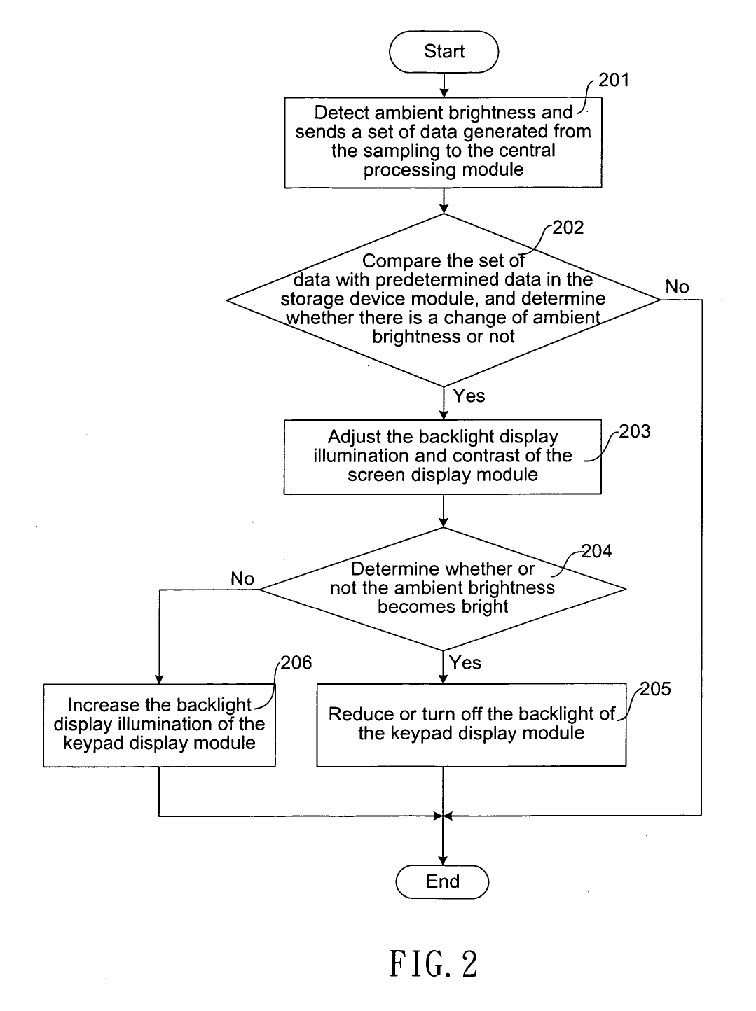

To make it easier for our examiner to understand the technical characteristics of the invention, we use a preferred embodiment together with the following operating procedure for the detailed description of the invention. Refer to FIG. 2 for the illustration of the procedure how the handheld device 10 automatically adjusts the illumination of the screen display module 15 as follows:

(Step 201) Firstly, the detecting module 11 detects ambient brightness and performs sampling and analog-to-digital conversion and then sends the set of data generated from the sampling to the central processing module 12.

(Step 202) The central processing module 12 compares the set of data with predetermined data in the storage device module 13, and in the meantime, the set of data is compared with a previously sampled data, and the result of the comparison between the set of data and said predetermined brightness data is used for determining whether there is a change of ambient brightness or not. When there is a change, then go to Step 203; and when there is no change, then end the procedure for adjusting the backlight display illumination.

(Step 203) This step adjusts the backlight display illumination and contrast of the screen display module 15.

(Step 204) This step determines whether or not the ambient brightness is bright. When the brightness becomes brighter, then go to the Step 205; when the brightness doesn't become brighter, then go to Step 206.

(Step 205) This step reduces the backlight display illumination of the keypad display module 14 or turns off the backlight of the keypad display module 15 and then ends the procedure of adjusting the backlight display illumination.

(Step 206) This step increases the backlight display illumination of the keypad display module 14 and then ends the procedure of adjusting the backlight display illumination.

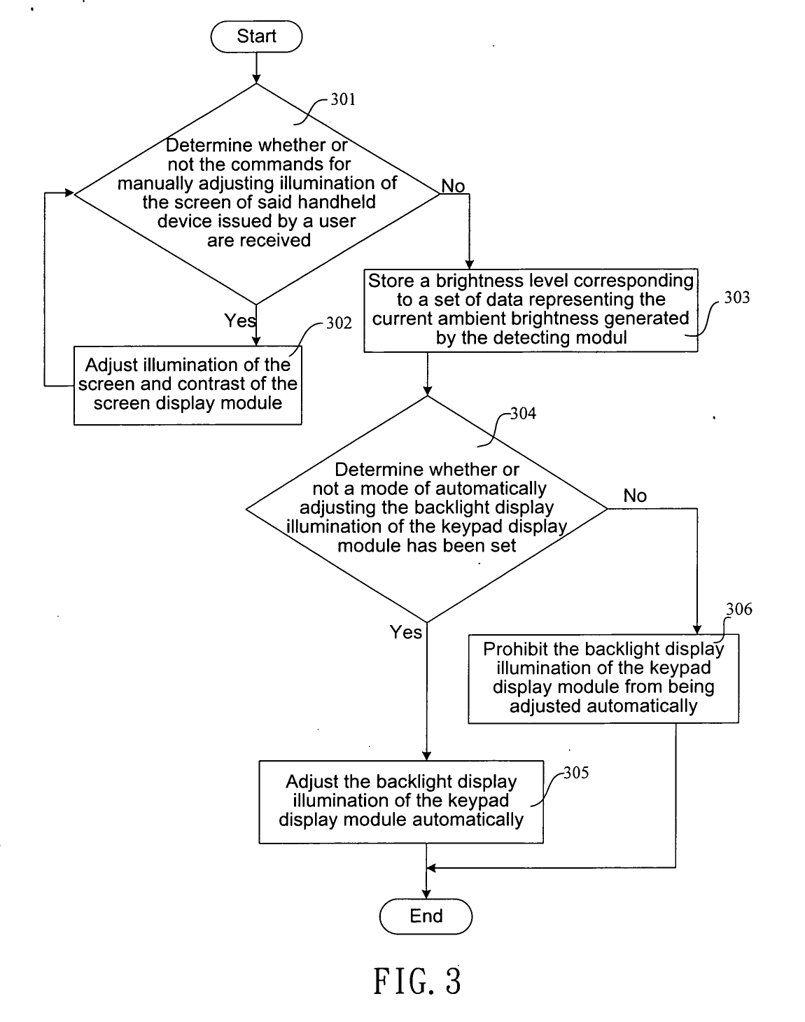

Further, when a user is not satisfied with the settings of the backlight display illumination and contrast of the screen display module 15 at the current mode, the user can modify the settings manually to meet the user's requirements and the related operation procedure as shown in FIG. 3 is described below:

(Step 301) Firstly, the central processing module 12 determines whether or not the commands for manually adjusting illumination of the screen of said handheld device issued by a user are received. When the commands for manually adjusting the illumination of the screen of said handheld device issued by a user are received, then go to Step 302; and when the commands for manually adjusting the illumination of the screen of said handheld device issued by a user are not received, then go to Step 303.

(Step 302) This step adjusts illumination of the screen and contrast of the screen display module 15 according to the user's manual adjustment operation and then returns to Step 301.

(Step 303) This step stores a brightness level corresponding to a set of data representing the current ambient brightness generated by the detecting module 11.

(Step 304) This step determines whether or not a mode of automatically adjusting the backlight display illumination of the keypad display module 14 has been set; when yes; when yes, then go to Step 305, or else go to Step 306.

(Step 305) This step adjusts the backlight display illumination of the keypad display module 14 automatically and then ends the procedure of adjusting the backlight display illumination.

(Step 306) This step prohibits the backlight display illumination of the keypad display module 14 from being adjusted automatically and then ends the procedure of adjusting the backlight display illumination.

While the invention herein disclosed has been described by means of specific embodiments, numerous modifications and variations could be made thereto by those skilled in the art without departing from the scope and spirit of the invention set forth in the claims.

What is claimed is:

1. A method used in a handheld device for automatically adjusting illumination of a screen of the handheld device according to ambient, with respect to the handheld device, brightness, the handheld device comprising a detecting module for detecting the ambient brightness and a central processing module, the method comprising the steps of:
generating a set of data representing said ambient brightness;
comparing the set of data with predetermined brightness data that represent a plurality of different brightness levels and are stored in a storage module of said handheld device; and
adjusting illumination of the screen of said handheld device according to a result of the comparison between the set of data and said predetermined brightness data.

2. The method of claim 1, wherein said detecting module comprises a transducer and a conversion chip, and said transducer is provided for detecting said ambient brightness, and said conversion chip is provided for sampling and performing analog-to-digital conversion to generate the set of data representing said ambient brightness.

3. The method of claim 1, wherein illumination of the screen of said handheld device is performed by a backlight module of said handheld device.

4. The method of claim 1, further comprising a step of adjusting contrast between different display elements on the screen according to the result of the comparison between the set of data and said predetermined brightness data.

5. The method of claim 1, wherein the step of adjusting the illumination of the screen comprises increasing the illumination of the screen when said ambient brightness becomes less bright.

6. The method of claim 1, wherein the step of adjusting the illumination of the screen comprises reducing the illumination of the screen when said ambient brightness becomes brighter.

7. The method of claim 1, further comprising a step of adjusting illumination of a keypad display of said handheld device after adjusting the illumination of the screen of said handheld device.

8. The method of claim 7, wherein the step of adjusting the illumination of the keypad display comprises reducing or turning off the illumination of said keypad display when said ambient brightness becomes brighter.

9. The method of claim 7, wherein the step of adjusting the illumination of the keypad display comprises increasing the illumination of said keypad display when said ambient brightness becomes less bright.

10. The method of claim 7, wherein said central processing module performs the steps of:
storing a brightness level corresponding to the set of data representing said ambient brightness when no command for manually adjusting illumination of the screen of said handheld device issued by a user is received; and
adjusting said illumination of the keypad display of said handheld device automatically when a mode of automatically adjusting the backlight display illumination of the keypad display module 14 has been set.

11. The method of claim 10, wherein said illumination of said keypad display is prohibited from being adjusted automatically when no command to automatically adjust said illumination of said keypad display issued by a user is received.

12. The method of claim 10, wherein said illumination of said screen is changed when a command to adjust said illumination of said screen issued by a user is received.
